(19) United States
(12) Patent Application Publication
(10) Pub. No.: US 2024/0184860 A1
(43) Pub. Date: Jun. 6, 2024

(54) METHODS AND ARRANGEMENTS FOR PROVIDING IMPACT IMAGERY

(71) Applicant: IMPACT IMAGERY GmbH, Elsbethen (AT)

(72) Inventors: Christoph BRODOWICZ, Salzburg (AT); Marc Stefan STICKLER, Elsbethen (AT); Lukas FABRYKOWSKI, Vienna (AT)

(73) Assignee: IMPACT IMAGERY GmbH, Elsbethen (AT)

(21) Appl. No.: 18/074,539

(22) Filed: Dec. 5, 2022

(51) Int. Cl. G06F 21/10; G06F 16/583; G06F 16/587; G06V 10/764; H04L 9/00; H04L 9/32

(52) U.S. Cl. CPC G06F 21/10; G06F 16/583; G06F 16/587; G06V 10/764; H04L 9/3268; H04L 9/50; H04L 2209/608

(57) ABSTRACT

The present invention relates to methods for digital photograph certification and providing same to a user according to a user request, based at least in part on one or more of a first characteristic extracted from the digital photograph and a second characteristic based on metadata associated with the digital photograph, and a digital photograph identifier associated with the digital photograph and/or a user identifier associated with a user of the digital photograph. The present invention further comprises related apparatuses, systems, computer programs and computer-readable mediums configured to store and/or execute instructions to thereby cause the implementation of the aforementioned methods.

### TECHNICAL FIELD OF THE INVENTION

The present invention relates to the field of computer-implemented techniques for classifying and/or certifying digital photographic images. In particular, the present disclosure provides computer-implemented methods and systems configured to process digital photographs and to reliably verify the origin of such photographs according to a corresponding digital footprint.

### BACKGROUND OF THE INVENTION

Ubiquitous access to the Internet and social media has created an unparalleled demand for digital content including digital images and photographs. This has given rise to so-called stock photography platforms, which typically offer large collections of high-quality digital photographs. Users can typically search such platforms using keywords associated with photographs or images that feature desired content to thereby access a vast library of suitable digital photographs over the Internet. According to recent statistics, the global stock photography space has a market of approximately 4.7 billion USD, and a yearly growth currently projected to be 6.8%. Users and companies across a variety of creative industries including, for instance, marketing agencies, media and publishing companies, film and TV producers, as well as business and individual creators, often use stock photographs on a regular basis and may compensate independent photographers, content generators and platforms to access such original digital content.

Digital photographs are typically stored as data in computer-readable files that further include metadata for identifying particular properties of each photograph. For instance, metadata for a digital photograph typically includes data pertaining to the camera settings used to capture the photograph, image metrics such as resolution and color space, date and time information, and location information. This metadata may also store the username or other properties identifying the entity (e.g., photographer) that originated the photograph.

However, metadata associated with the digital photograph does not typically include auxiliary data concerning other of the non-photographer entitles participating in the digital photograph creation processing. Examples of such non-photographer entities may include the object (e.g., person, animal or landscape) shown in the photograph, or more generally, other collaborative activities otherwise associated with the digital photograph. Such auxiliary data relating to the non-photographer entitles are normally not present/acknowledged in the data associated with the digital photograph when such photograph is processed on a stock photography platform, or even subsequently when the digital photograph is used by the end user, e.g., where the photograph is uploaded to a website, storage server, or the like.

Moreover, digital photographs, like digital data in general, many be easily modified. In particular, the metadata of a digital photograph many be easily edited, overwritten or even be unintentionally erased when the digital photograph is converted from one digital format to another. Consequently, even if all data, including metadata, associated with the digital photograph is apparently otherwise complete, the associated data may easily be lost over time and space as the digital photograph is subject to processing on, e.g., an online platform, such as a stock photography platform.

In view of this potential undesirable loss of data in connection with a digital photograph, a complete, reliable, and verifiable association of digital photographs that accurately reflects all associated data, including those entities participating in any aspect of the digital photography creation process, remains an unsolved technical problem. In turn, downstream processing, such as proper preservation of data, including data attributed to all participating entities for a variety of purposes remains difficult or even impossible.

Accordingly, there is a need for an improved, highly efficient technique for reliably and permanently associating digital photographs that accurately reflects all data, including metadata and any entity source participating in any aspect of the digital photography creation process and ensuing lifecycle, wherein such an association is verifiable as the digital photograph circulates through the Internet or elsewhere in the digital space, in particular through digital processing platforms and format transformation protocols.

### SUMMARY OF THE INVENTION

In one aspect of the invention, a computer-implemented method may be provided. The method may be a photograph certification method. A corresponding apparatus or system to implement the methods herein, for instance, a photograph certification apparatus, is also described.

In some embodiments, the presently disclosed methods comprise assigning a digital photograph to one or more predefined classes. The assigning step may be based at least in part on one or more characteristics, for instance, a first characteristic, which is extracted from the digital photograph, and, for instance, a second characteristic based on metadata associated with the digital photograph.

In some embodiments, the disclosed methods may include receiving a certification request from a requesting computer process at a certification server. The certification request may comprise a digital photograph identifier associated with the digital photograph. The certification request may alternatively or concurrently comprise a user identifier associated with a user of the digital photograph.

In some embodiments, the disclosed methods may include creating, by the certification server, a certification data entry. The certification data entry may be created in a non-transitory storage means or medium. The certification data entry and/or the storage means may store at least the digital photograph identifier and/or the user identifier.

In one aspect, the disclosed methods may include creating, by the certification server, a certified copy of the digital photograph. A link to the certification data entry may be embedded in the certified copy of the digital photograph.

In some embodiments, the disclosed methods may further comprise providing, by the certification server, the certified copy of the digital photograph to the requesting computer process.

One advantage associated with the methods according to the present invention, including the aforementioned steps, or at least a subset thereof, is that a certificate can be assigned to the digital photograph thereby documenting the entities participating in the photograph creation process, depending on the class(es) assigned to the digital photograph. Because the link to the certification data entry is embedded in the certified copy of the digital photograph, this certification link travels with the certified copy and thus the certified copy can be readily verified by a user of the digital photograph.

Furthermore, the step of creating, by the certification server, a certification data entry in a non-transitory storage means, allows storing a verified record for the digital photograph(s) that are certified. In some embodiments, the non-transitory storage means may be selected from databases, blockchain systems, and physical storing devices (e.g., SSD, HDD, CD, DVD, MicroSD, MiniSD, and equivalent devices).

In some embodiments according to the present invention, the certification server may operate on a computer system separate from a computer system initiating the requesting computer process. The computer system of the certification server and the computer system initiating the requesting computer process may be configured for communicating over a network connection, in particular over the Internet. An advantage of such embodiments is that a Certification-as-a-Service (CaaS) can be implemented, for example, using an application programming interface (API), web service architecture, or similar communication protocols between computing systems or architectures known by a person skilled in the art. In this way, any existing photography platform, e.g., a stock photo platform, may seamlessly integrate the certification techniques disclosed herein. The disclosed certification techniques may be used by multiple separate photography platforms. Furthermore, the processing power required by the certification process does not influence the operation of the computer system of the requesting computer process. In addition, the certification process can be performed for multiple requesting computer processes and corresponding computer systems which further improves scalability.

In some embodiments of the methods described herein, the computer system of the requesting computer process is a stock photo platform configured for storing the digital photograph. An advantage of such embodiments is that the system can be used on an already existing stock photo platform, e.g., such as Pixabay, Adobe Stock, Shutterstock, Getty Images, Canva, and any similar or equivalent stock photo platform known by a person skilled in the art. This aspect thus simplifies the data management and reduces the need for having independent databases and computer systems configured to store the digital photographs.

In some aspects of the methods described herein, the certification server may be accessible via an application programming interface or a web service. These embodiments reduce the usage of computer resources, such as memory, database capacity, and processing resources needed to carry on the steps of the instant methods, compared to the case of having this service executed locally in the computer system that executes the remaining steps of the methods according to the present invention.

In some embodiments of the methods described herein, the certification server and the requesting computer process operate on the same computer system. The computer system may be configured for storing the digital photograph. An advantage of this embodiment is that the communication between the certification server and the requesting computer process is local, hence reducing the risk of experiencing communication failures that can be present in architectures and systems that use APIs and web services.

In some embodiments of the methods described herein, assigning the digital photograph to one or more predefined classes may comprise automatically extracting landscape information as the first characteristic from the digital photograph. The landscape information may indicate at least part of a scene shown in the digital photograph. An advantage of these embodiments is that the method can identify with non-touch computer process elements that appear in the digital photograph and extract data and/or metadata. This increases the speed of the process compared to the case where a user must enter metadata manually for each element, or for a set of key elements that are shown in the digital photograph. A computer-based image classification may also be more reliable and less biased than a classification by a human operator.

In some embodiments of the methods described herein that include assigning the digital photograph, the step may comprise automatically extracting landscape information from the digital photograph. The automatic extracting of the landscape information may comprise processing the digital photograph using an image classification machine-learning algorithm or method. The image classification machine-learning algorithm or method may be based on supervised or unsupervised training methods, reinforcement learning methods, deep learning methods, or any other methods for training machine-learning models.

In some aspects, the machine-learning algorithm or method may have been previously trained to classify one or more of an object shown in the digital photograph, e.g., an animal; a person shown in the digital photograph, preferably including an ethnicity and/or social affiliation of the person; a natural environment shown in the digital photograph; a topic such as pollution, hunger, climate change and/or war. An advantage of these embodiments is that the methods can identify objects and classes related to a project associated with a use of the digital photograph, and may generate data that can be used as input in an external process associated with the project. For example, the methods may generate a command to be sent to an external computer system that manages a donation network, or payments network. The external computer system may send notifications to a non-profit organization account or terminal each time a certified copy is created from a digital photograph classified by the machine-learning algorithm or method. Such applications according to the present invention are exemplary.

In any of the embodiments according to the present methods, the step of assigning the digital photograph to one or more predefined classes may further comprise extracting information from the metadata associated with the digital photograph. The extracted information may include one or more of geolocation information indicating where the digital photograph was taken; photographer information indicating the entity taking the digital photograph; and landscape information indicating at least part of a scene shown in the digital photograph. These embodiments allow having enhanced information associated with the digital photograph that may be used in the step of creating, by the certification server, a certification data entry, and the step of creating, by the certification server, a certified copy of the digital photograph. Furthermore, this information may be used by a web scraping system/method or a search engine to classify and/or group the digital photograph with other similar digital photographs.

In some embodiments of the methods disclosed herein, assigning the digital photograph to one or more predefined classes may comprise automatically matching the first characteristic and/or the second characteristic extracted from the digital photograph with information about the one or more predefined classes. For example, the automatic matching may include using a machine-learning algorithm or method. This beneficially allows having a non-touch classification of the digital photograph that takes into account the predefined project, thereby reducing steps that could be done manually by an administrator user.

In any of the embodiments according to the present methods, the step of assigning the digital photograph to one or more predefined classes may a comprise receiving the digital photograph from a computer system, preferably a computer system on which a stock photo collection is stored; and storing the digital photograph in a non-transitory storage means of a computer system on which the certification server operates. For example, the assigning step may be performed independently of a user request and on behalf of a stock photo platform. When a user wants to access the photo following the user request, the user may indicate this to the stock photo platform, which may then send the certification request. An advantage of these embodiments is that, after the digital photograph is stored in the non-transitory storage means and has been classified in the assigning step, the certification request can be carried out rapidly once this request is received by the certification server. Further, the certification request itself is small in size because it does not need to contain the photograph to be certified. Instead, an identifier of the digital photograph is sufficient and the digital photograph itself can be obtained from the (local) storage of the certification server. Accordingly, this advantageously allows reducing the payload of digital photograph files being sent during the continuous operation of the present methods, thus enabling a faster and more stable communication protocol, which contributes to lower page loading times in the terminals and/or computer systems executing the instant methods.

Any of the embodiments according to the present methods may further comprise a step of storing the certification data entry and/or the certified copy of the digital photograph in a long-term storage means. The long-term storage means may comprise a distributed ledger technology (DLT) system, for example, a blockchain network. The long-term storage means may comprise an InterPlanetary File System (IPFS) system. An advantage of these embodiments is an improved security of the system and prevention of cyberattacks directed to altering the certificates and/or generating/validating counterfeit copies of the digital photograph. Moreover, these embodiments ensure that the certificates remain valid even in cases where the certification server is not available temporally or even permanently.

In any of the embodiments according to the methods described herein, the certification data entry may comprise an indication of the user of the digital photograph, such as a name and/or an identifier of the user; an indication of the digital photograph, such as an identifier of the photograph; and an indication of one or more predefined classes assigned to the digital photograph, such as an identifier of the class or each assigned class. Optionally, the certification data entry may further include additional data, e.g., one or more of a time of purchase; an expiry time of the (allowed) usage of the digital photograph by the user; and one or more usage terms, such as “print only”. Accordingly, the certification data entry may define and dictate how the photograph can be used, including how it can be processed by a technical device such as a printer. In these aspects, the certification data entry can be understood to comprise or define control signals for restricting actions that can be performed on the digital photograph by a technical device.

In any of the embodiments according to the methods described herein, the link to the certification data entry may be established through linking information embedded in the certified copy of the digital photograph. The linking information may enable locating the certification data entry, preferably via a uniform resource identifier (URI). A URI is a unique sequence of characters that identifies a resource used by web technologies. The URI may provide a means of locating and retrieving information resources on a network (such as the Internet). The URI may be a uniform resource locator (URL) For example, the linking information may be embedded in a visible element of the certified copy of the digital photograph, such as a watermark, logo, emblem, symbol or a machine-readable code. The linking information may also be embedded in an invisible element of the certified copy of the digital photograph, such as a metadata entry or steganographic information. The invisible element is invisible to the typical human perception, although there might be differences on pixel level imposed on the digital photograph.

In general, steganography is the practice of representing information within another message or physical object in a manner that the presence of the information is not evident to human inspection. For example, a steganographic approach applied to JPEG images is disclosed in the document Tchakounte, Franklin & Kamdem, Priva & Kamgang, Jean Claude & Tchapgnouo, Hortense & Atemkeng, Marcellin. (2020). An Efficient DCT-SVD Steganographic Approach Applied to JPEG Images. EAI Endorsed Transactions on Industrial Networks and Intelligent Systems. 7. DOI: http://dx.doi.org/10.4108/eai.28-9-2020.166365, Retrieved from https://www.researchgate.net/publication/344784977_An_Efficient_DCTSVD_Steganogra phic_Approach_Applied_to_JPEG_Images on 28 Nov. 2022.

The methods according to the present invention may further comprise receiving a verification request at a verification server, the verification request comprising the certified copy of the digital photograph, an indication of the certified copy of the digital photograph, the digital photograph, or an indication of the digital photograph. The methods herein may also comprise a step of obtaining the certification data entry corresponding to the digital photograph; and a step of transmitting and/or causing a displaying of at least part of the information stored in the certification data entry. The verification server and the certification server may operate on the same or on different computer systems.

The present disclosure further relates to an apparatus, in particular a photograph certification apparatus. The apparatus may comprise a memory configured for storing an assignment of a digital photograph to one or more predefined classes. The assignment may be based at least in part on one or more of a first characteristic extracted from the digital photograph and a second characteristic based on metadata associated with digital photograph. The apparatus may comprise a processor configured for executing a certification server. The certification server may be configured for performing any of the embodiments of the methods described herein.

The present disclosure also relates to a system comprising any of the embodiments of the apparatus herein and at least one computer system configured for hosting a stock photo collection.

The present disclosure further relates to a computer-readable storage means comprising instructions which, when executed by a computer, cause the computer to carry out any of the embodiments of the methods according to the present invention. A data processing apparatus or system is also provided comprising means for carrying out any of the embodiments of the instant methods. Similarly, the present disclosure also relates to a computer program, or a computer-readable means having stored there on a computer program, the computer program comprising instructions which, when the program is executed by a computer, cause the computer to carry out any of the embodiments of the methods according to the present invention.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 shows a flow diagram of an embodiment of the methods described herein. The flow diagram illustrates blocks of steps including assigning a digital photograph to one or more classes, receiving a certification request, creating a certification data entry, creating a certified copy of the digital photograph and providing the certified copy by a certification software server.

FIG. 2 shows a block diagram of the embodiment of the method illustrated in FIG. 1.

FIG. 3 shows a block diagram of an embodiment of the methods described herein that illustrates a computer system of a certification software server, and a computer system of a requesting computer process.

FIG. 4 shows a block diagram of an embodiment of the methods described herein that illustrates a computer system associated with a certification software server, and a requesting computer process.

FIG. 5 shows a flow diagram of an embodiment of the methods described herein including sub-steps for the step of assigning a digital photograph to one or more predefined classes.

FIG. 6 shows a block diagram of an embodiment of the methods described herein that illustrates an image classification machine-learning process.

FIG. 7 shows a block diagram of an embodiment of the methods described herein that illustrates an image classification machine-learning process and zooms in on details about landscape information and data associated with the digital photograph.

FIG. 8 shows a block diagram of an embodiment of the methods described herein that illustrates an image classification machine-learning process, and an automatically matching process that compares project information with information associated to the digital photograph.

FIG. 9 shows a flow diagram of an embodiment of the methods described herein including sub-steps for the step of assigning a digital photograph to one or more predefined classes and a step of storing the certification data entry or certified copy of the digital photograph in a long-term storage means.

FIG. 10 shows a block diagram of an embodiment of the methods described herein that illustrates details of a distributed ledger technology (DLT) system and an InterPlanetary File System (IPFS) system that receive a certified copy of the digital photograph.

FIG. 11 shows a block diagram of an embodiment of the apparatus described herein, illustrating a processor and a memory, the processor configured to execute steps of the presently disclosed methods.

FIG. 12 shows a flow diagram of an embodiment of the methods described herein comprising a step of storing the certification data entry or certified copy of the digital photograph in a long-term storage means.

FIG. 13 shows a flow diagram of an embodiment of the methods described herein comprising a step of storing the certification data entry or certified copy of the digital photograph in a long-term storage means, a step of obtaining the certification data entry, and a step of transmitting and/or causing a displaying of the information stored in the certification data entry.

### DETAILED DESCRIPTION OF THE INVENTION

The embodiments disclosed herein are for purposes of illustrating the technical operations underlying the instant invention. Reference signs in the claims shall not be construed as limiting the claimed subject-matter. The word “comprising” and its variations does not exclude the presence of elements or steps other than those listed in any claim or the specification as a whole. The singular reference of an element does not exclude the plural reference of such elements and vice-versa.

The term “digital photograph” may include any type of digital imaging content obtained by techniques for digital photography, typically using cameras containing arrays of electronic photodetectors interfaced to an analog-to-digital converter (ADC) to produce images focused by a lens, as opposed to an exposure on photographic film. The digitized image is stored as a computer file amenable to further digital processing, viewing, electronic publishing, or digital printing. Throughout the present disclosure, the terms “digital photograph” and “digital image” may be used synonymously.

The term “server” may include a computer hardware or software (computer program) that provides functionality for other programs or devices, referred to as “clients”. This architecture is known as a client-server model. Servers can provide various functionalities, often called “services”, such as sharing data or resources among multiple clients, or performing computation for a client. A single server can serve multiple clients, and a single client can use multiple servers. A client process may run on the same device or may connect over a network to a server on a different device.

The term “computer process” may include an instance of a computer program that is being executed by one or many threads. Most computer processes are rooted in an operating system (OS) process which comprises the program code, assigned system resources, physical and logical access permissions, and data structures to initiate, control and coordinate execution activity. Depending on the OS, a process may be made up of multiple threads of execution that execute instructions concurrently.

The term “identifier” may include any name or piece of information that identifies (i.e., labels the identity of) either a unique object or a unique class of objects. The abbreviation ID often refers to identity, identification (the process of identifying), or an identifier (i.e., an instance of identification). An identifier may be a word, number, letter, symbol, or any combination thereof.

The term “metadata” may include data that provides information about other data, but not the content of the data, such as the text of a message or the image itself. In the field of digital photography, the exchangeable image file format (officially Exif, according to JEIDA/JEITA/CIPA specifications) is a standard that specifies formats for images, sound, and ancillary tags used by digital cameras (including smartphones), scanners and other systems handling image and sound files recorded by digital cameras. The specification uses the following existing encoding formats with the addition of specific metadata tags: JPEG lossy coding for compressed image files, TIFF Rev. 6.0 (RGB or YCbCr) for uncompressed image files, and RIFF WAV for audio files (linear PCM or ITU-T G.711 μ-law PCM for uncompressed audio data, and IMA-ADPCM for compressed audio data).

The term “user” may include any type of recipient, consumer, purchaser, possessor, owner, tenant, licensee, renter or other type of person which has an interest in using the corresponding digital photograph. In the context of stock photo platforms, a single photograph can typically be used by multiple users.

The “one or more predefined classes” may include any type of grouping of any number of digital photographs. In some contexts, assigning a digital photograph to one or more predefined classes may mean tagging the digital photograph based on its content, e.g., by tagging persons, animals and/or venues shown in the photograph. The “assigning” may also comprise associating a digital photograph with one or more ventures, undertakings and/or activities or other aspects that need not be directly depicted but may be otherwise associated with the digital photograph.

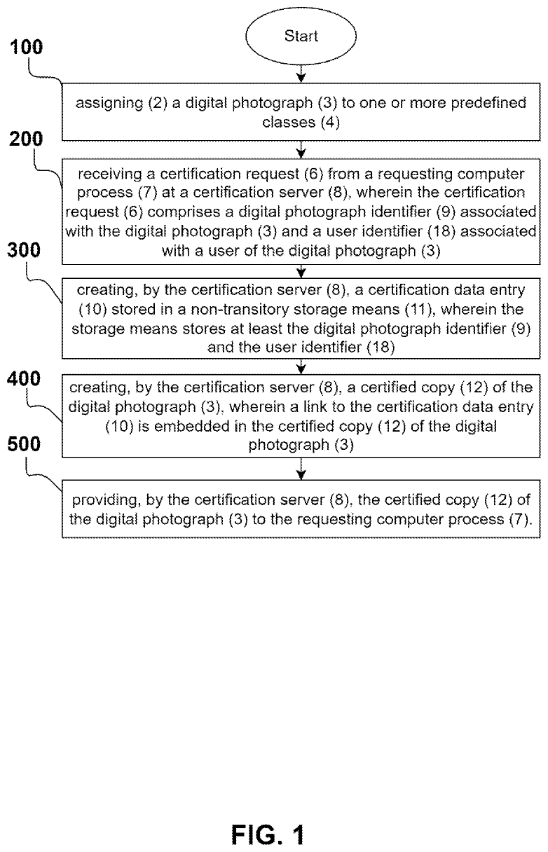

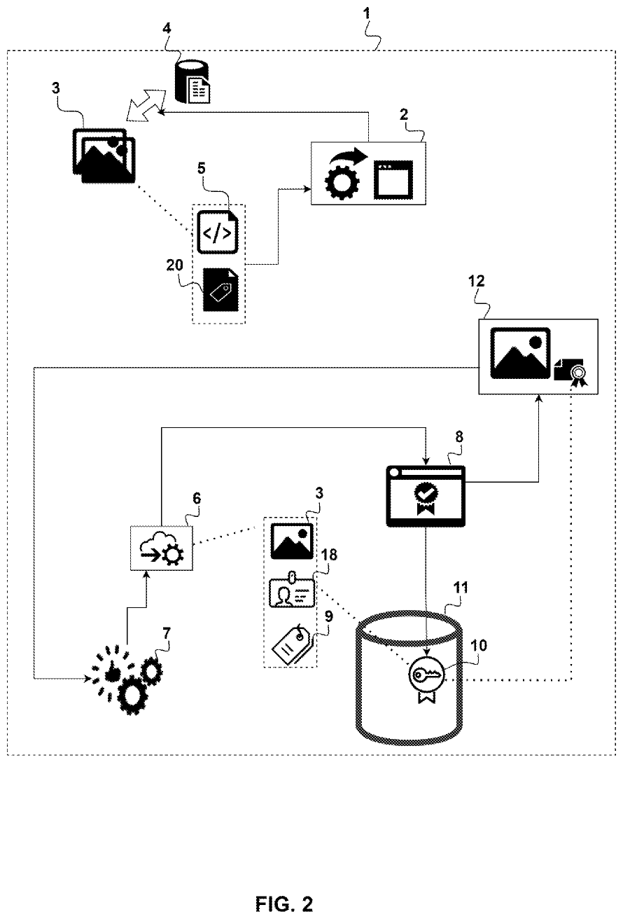

Referring to FIG. 1 and FIG. 2, embodiments of the photograph certification method (1) shown therein comprise multiple processing steps, including step (100) of assigning (2) a digital photograph (3) to one or more predefined classes (4), the assigning (2) being based at least in part on one or more of a first characteristic (5) extracted from the digital photograph (3) and a second characteristic (20) based on metadata associated with the digital photograph (3). Method (1) also comprises a step (200) of receiving a certification request (6) from a requesting computer process (7) at a certification server (8), wherein the certification request (6) comprises a digital photograph identifier (9) associated with the digital photograph (3) and a user identifier (18) associated with a user of the digital photograph (3). The method (1) further comprises a step (300) of creating, by the certification server (8), a certification data entry (10) stored in a non-transitory storage means (11), wherein the storage means stores at least the digital photograph identifier (9) and the user identifier (18). The method (1) further comprises a step (400) of creating, by the certification server (8), a certified copy (12) of the digital photograph (3), wherein a link to the certification data entry (10) is embedded in the certified copy (12) of the digital photograph (3); and a step (500) of providing, by the certification server (8), the certified copy (12) of the digital photograph (3) to the requesting computer process (7).

One advantage of the instant method embodiments comprising these steps (100, 200, 300, 400, 500) is that a certificate can be assigned to the digital photograph (3), which allows, for instance, verifying certain data in connection with the photograph (3), including any registered copyright, license, and related permissions and associations, which, for example, may be related to a project (4). This processing thus allows for ready tracking and identification of the digital photograph (3). For example, the certificate may be related to a non-profit association or community that receives a donation for each certificate generated.

According to the methods (1) described herein, the digital photograph (3) may be a digital image file. For example, the digital photograph (3) may be a “stock photo” (e.g., a photograph that is part of a stock photo collection stored in a memory). In case the digital photograph (3) is a stock photo, it may be licensed or otherwise used and/or accessed by multiple users through a stock photo platform upon request. Examples of stock photo platforms include Adobe Stock, Shutterstock, Getty Images, Canva, Pixabay, and any other similar and/or equivalent stock photo platforms known by a person skilled in the art.

The global stock photography market has recently experienced significant growth. For instance, as described above, this market currently has a market value of about 4.7 billion USD, with an expected year-on-year growth of about 6.8%. Users and companies from a variety of creative industries and businesses, e.g., marketing agencies, media & publishing companies, film & TV producers, and businesses/individual creators use, on a regular basis, stock photographs and typically compensate the originating photographers and content generators for original images using a variety of means. Complying with the governing copyright laws is paramount, since such digital photographs and images are commonly utilized for purposes that reach a large audience, such as campaigns, videos, films, performances, and other projects and/or products.

Accordingly, methods herein allow these users and companies to become legitimate users of the digital photograph (3), by providing, e.g., a certified copy (12) and certification data entry (10) thereby permitting verification of an authorized use of the photograph (3). Each legal user preferably is related to a user identifier (18). The user identifier (18) may be a data file or structure including values of an identification variable configured to validate the identity of a user (e.g., ID, passport number, drivers license number, biometric data, e-signatures, and any other similar variable or data known by a person skilled in the art).

Furthermore, step (100) relating to assigning (2) a digital photograph (3) to one or more predefined classes (4), may allow the user or company to contribute to a social and/or environmental cause, such as a non-profit foundation, to preserve wild-life, environment, sustainability, education, conservation or any other social/environmental cause. For example, step (100) of assigning (2) a digital photograph (3) to one or more predefined classes (4) may allow the user or company to legally advertise that they are contributing to the social or environmental cause.

Examples of such non-profit foundations include foundations linked to Sustainable Development Goals (UN), such as: no poverty, zero hunger, good health and well-being, quality education, gender equality, clean water and sanitation, affordable and clean energy, decent work and economic growth, industry, innovation and infrastructure, reduced inequality, sustainable cities and communities, responsible consumption and production, climate action, life below water, life on land, peace, justice, and strong institutions, partnerships to realize such goals.

Furthermore, the digital photograph (3) may relate to digital photography in general, e.g., photos published by photographers specializing in photographs of wildlife, independent users, amateur photographers, designers, editors or any other person or entity able to generate a digital photograph (3) or equivalent digital image file.

Referring to FIG. 1 and FIG. 2, step (100) of assigning (2) a digital photograph (3) to one or more predefined classes (4) may be implemented by a process comprised by the instant methods (1). For example, the step (100) of assigning (2) a digital photograph (3) to one or more predefined classes (4) may be generated by a classification process receives as input the digital photograph (3) and its characteristics (5, 20) that may be visual or may be metadata. The class assigning (2) may be stored in a data element such as a file, vector, matrix, or any other data element known by a person skilled in the art. The classification process that obtains the class assigning (2) may also be executed by a processor (34), computing unit, server or any other equivalent computing system known by a person skilled in the art.

A first characteristic (5) may include data configured to process the content or topic (25) of the digital photograph (3). For example, a first characteristic (5) may include one or more tags associated to pixel patterns that represent an element, location information (26), animal (22), person (23), natural environment (24) or any other element, entity of class associated to the image shown by the digital photograph (3). Accordingly, a first characteristic (5) may be generated manually or automatically. In case the first characteristic (5) is generated manually, a user that uploads the digital photograph (3) to a database or server, may enter metadata in a form associated with the digital photograph (3).

According to the methods herein, the term “data” or “information” refers to a symbolic representation that may be numeric, alphabetic, algorithmic, logical, and/or vectorial that encodes information. Data may have a structure or frame composed of blocks of characters or bits representing different types of information. Each block is made up of character strings, numbers, and logical symbols, among others.

The data can also be formed only of bits (strings in binary language), of characters formed one by one by a combination of bits, from fields, records, or tables formed from fields and records, or formed from data interchange files (e.g., formats such as csv, json, xls, among others). In addition, data may be a matrix of n rows by m columns. In turn, data many contain one or more sets of data.

For example, when the data includes a frame structure, the frame may have a block of identifying characters, generally known as a header, which contains information related to a computing device or processor sending the data, and may contain information related to a computing device or processor receiving the data. Preferably, if data is in a frame format, the frame contains blocks related to layers according to the OSI reference model.

The frame may additionally include a tail character block that identifies a computing unit or server that is the end of the data, i.e., after that block there is no more information contained in the data previously identified by the computing unit or server with the header. In addition, the data can have between the “header” block and the “tail” block, one or more character blocks representing statistics, numbers, descriptors, words, letters, logical values (e.g., Boolean) and/or combinations thereof.

According to the methods (1) herein, a dataframe (or dataset) refers to a specific type of data that has a matrix structure of rows and columns or has a table structure consisting of records and fields. Each row, column, field or record may be a data item. In addition, the data array may include a header, title or index to identify the data array, and may include indexes to identify fields and records (e.g., the dataframes used in Python Pandas).

Examples of data arrays include “datasets” or “dataframes” used in logical operations and computational processes programmed in languages such as Python (e.g., Pandas, NumPy), MatLab, R, and similar languages known to the person skilled in the art.

Referring to FIG. 1, step (200) of receiving a certification request (6) from a requesting computer process (7) at a certification server (8), allows a triggering of the steps (300, 400, 500) of the method (1). The certification request (6) may be generated by a terminal of a user who wants to obtain the certified copy (12) of the digital photograph (3). The certification request (6) may be generated by the same processor (34) or computing unit that executes the step (100) of assigning (2) a digital photograph (3) to one or more predefined classes (4). The requesting computer process (7) may be a conditional-based process that takes as input the class assigning (2), or a command that is generated each time the step (100) of assigning (2) a digital photograph (3) to one or more predefined classes (4) is executed.

FIG. 1 also shows the step (300) of creating, by the certification server (8), a certification data entry (10), and step (400) of providing, by the certification server (8), the certified copy (12) of the digital photograph (3) to the requesting computer process (7), thereby allowing responding to the certification request (6) with the certified copy (12) and certification data entry (10). Accordingly, in these steps (300, 400) of the method (1) are generated data and other information that allows a subsequent validating that a certified copy (12) of the digital photograph (3) is valid or false.

In step (300) a copy of the digital photograph (3) and/or a copy of the certified copy (12) and certification data entry (10) may be stored. A non-transitory storage means (11) may be used to store these documents and associate them to at least the indicated user identifier (18) and/or digital photograph identifier (9) of the digital photograph (3). Accordingly, in case a user identified by the user identifier (18) requests a digital photograph (3) that was previously processed, the method (1) may respond to the certification request (6) by sending the saved certified copy (12), without necessarily executing the steps (300, 400). In particular embodiments, the non-transitory storage means (11) may be selected from a database, one or more blockchain systems, and/or physical storing devices.

For example, the non-transitory storage means (11) may be a memory module that can be selected from the group that includes RAM (cache memory, SRAM, DRAM, DDR), ROM memory (Flash, Cache, hard disks, SSD, EPROM, EEPROM, removable ROM memories (e.g., SD (miniSD, microSD, etc.), MMC (MultiMedia Card), Compact Flash, SMC (Smart Media Card), SDC (Secure Digital Card), MS (Memory Stick), etc.), etc.), etc.). SD (miniSD, microSD, etc.), MMC (MultiMedia Card), Compact Flash, SMC (Smart Media Card), SDC (Secure Digital Card), MS (Memory Stick), etc.), CD-ROM, Digital Versatile Disc (DVD) or other optical storage, magnetic cassettes, magnetic tapes, storage or any other means that can be used to store information that can be accessed by a computing unit, device, server or equivalent computing system that is known to a person skilled in the art.

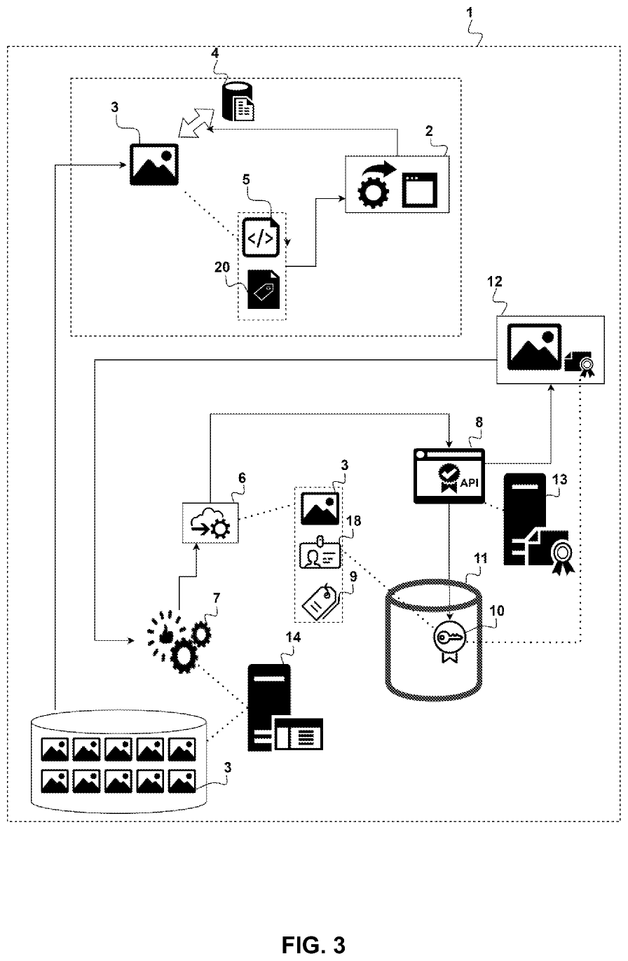

Referring to FIG. 3, in some of the embodiments of method (1), the certification server (8) may operate on a computer system (13) separate from a computer system (14) of the requesting computer process (7). An advantage provided by these embodiments is that the certification server (8) may be a Certification-as-a-Service (CaaS) platform. For example, the CaaS platform may be integrated by using an application programming interface (API), web service architecture, or similar communication protocols between computing systems or architectures known by a person skilled in the art.

FIG. 3 also shows that, in some embodiments of the presently disclosed method (1), the certification server (8) may be accessible via an application programming interface or a web service. An “application programming interface” or “API” may be described as a set of one or more computer-readable instructions that provide access to one or more other sets of computer-readable instructions that define functions and/or data types, so that such functions and/or data types can be configured to be executed on a computer in conjunction with an application program.

FIG. 3 further illustrates that, in some embodiments of the instantly disclosed method (1), the computer system (14) of the requesting computer process (7) is a stock photo platform configured for storing a digital photograph (3). An advantage provided by such embodiments is that they can be implemented in an already existing stock photo platform, such as Pixabay, Adobe Stock, Shutterstock, Canva, Getty Images, and similar or equivalent stock photo platforms known by a person skilled in the art. This configuration thus beneficially allows establishing a seamless integration that simplifies data management and reduces the need for having independent databases and computer systems configured to store digital photographs (3).

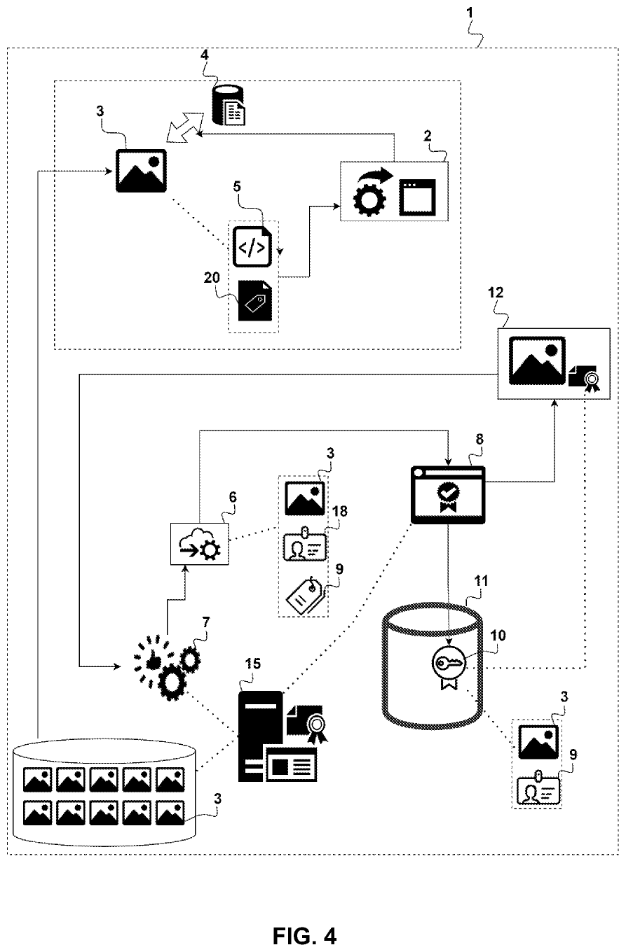

Referring to FIG. 4, in some embodiments relating to present method (1), the certification server (8) and the requesting computer process (7) operate on a computer system (15), wherein the computer system (15) is configured for storing the digital photograph (3). An advantage of this embodiment is that the communication between the certification server (8) and the requesting computer process (7) is local, hence this operational configuration reduces the risk of experiencing communication failures that are frequently present in architectures and systems that using non-localized APIs and web services.

The present embodiments further allow using a computer system (15), e.g., a server, computer, or equivalent computing system that may include a plurality of computing modules, (e.g., processing cores, virtual machines, or cloud computing architectures). One or more of the processing modules may be configured to execute requesting computer process (7). Similarly, one or more of the processing modules may be configured to execute the certification server (8).

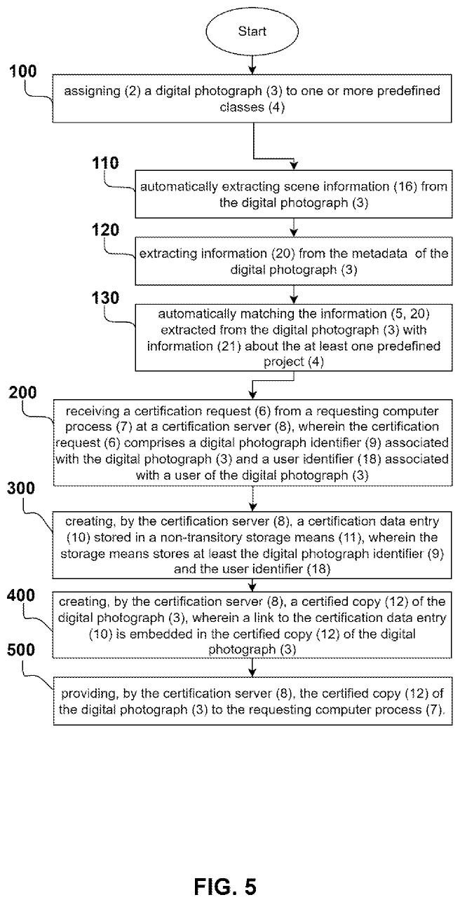

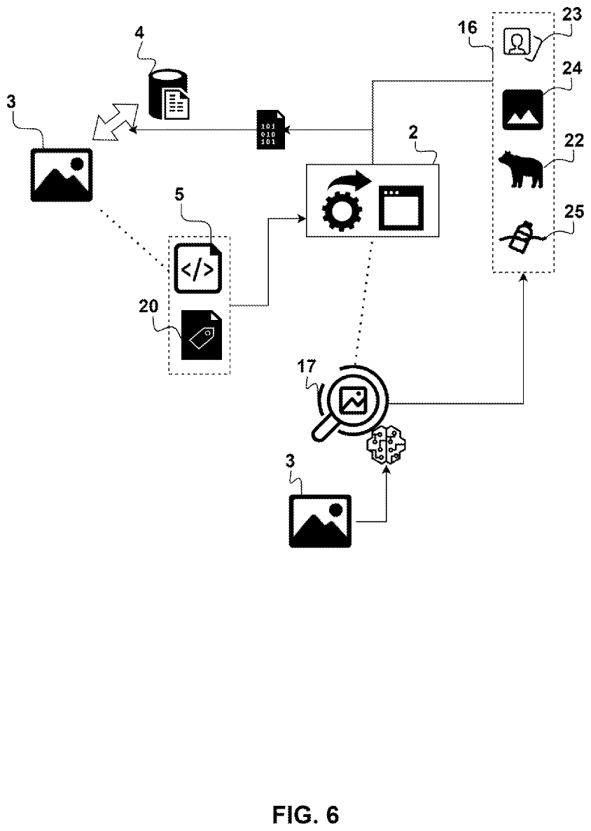

Referring to FIG. 5 and FIG. 6, in some embodiments of the present method (1), step (100) of assigning (2) a digital photograph (3) to one or more predefined classes (4) comprises a sub-step (110) of automatically extracting landscape information (16) from the digital photograph (3), the landscape information (16) indicating at least part of a landscape shown in the digital photograph (3).

Sub-processing step (110) for automatically extracting landscape information (16) from the digital photograph (3), can be executed by an automatic scanning process or image processing method configured to extract characteristics from the digital photograph (3). The automatic scanning process or image processing method may include one or more classification methods or machine learning algorithms configured to detect patterns, and transform the digital photograph (3) (e.g., reducing its size, removing colors, applying filters, removing elements, highlighting elements).

One of the advantages of these embodiments is that method (1) may identify with a non-touch computer process data element that appears in the digital photograph (3) and extract characteristics (5, 20), data and/or metadata. This increases the speed of the process in comparison to the situation where a user must manually enter metadata associated with each element appearing in the digital photograph (3), or for a set of key elements that are shown in the digital photograph (3).

Landscape information (16) may be any type of data or data structure (e.g., matrix, array, vector, dataset) that includes tags, records, values, or pixel patterns that allows a computer system to identify objects and scenarios in the digital photograph (3). For example, the landscape information (16) may be configured to identify with a computer system an animal (22), a person (23), a natural environment (24), or any other element associated with a topic (25).

Referring to FIG. 5 and FIG. 6, in some embodiments of the instant method (1), sub-step (110) of automatically extracting of the landscape information (16) comprises processing the digital photograph (3) using an image classification machine-learning process (17) or algorithm. The image classification machine-learning process (17) may include one or more computer visualizing processes or methods. Examples of computer vision methods, are principal component analysis (PCA), kernel methods, statistical methods, scale invariant feature transform (SIFT), feature extraction, accelerated robust features (SURF), histogram oriented gradient localization histogram (GLOH), DAISY, oriented FAST and rotated BRIEF (ORB), binary robust scalable key points (BRISK), histogram of oriented gradients (HOG), and any other computer vision method known to a person skilled in the art.

In order to identify a person (23) or an animal (22), the image classification machine-learning process (17) may include facial recognition computational methods for such as Haar-type templates, facial landmark identification, statistical modeling, color analysis or similar techniques known to a person skilled in the art.

Referring to FIG. 5 and FIG. 6, in some embodiments of the presently disclosed methods (1), the machine-learning process (17) may be previously trained to classify one or more of an animal (22) shown in the digital photograph (3); a person (23) shown in the digital photograph (3), preferably including an ethnicity and/or social affiliation of the person; a natural environment (24) shown in the digital photograph (3); and/or a topic (25) such as pollution, hunger, climate change and/or war.

An advantage of these embodiments is that method (1) can identify objects and classes related to a project (4) associated with the digital photograph (3), and generate data that may be used as input in an external process associated with the project. By way of example, a command configured may be generated to be sent to an external computer system that manages a second network, e.g., an academic database, a donation network, or a payment network. The external computer system may thus send notifications to a non-profit organization account or terminal each time a certified copy (12) is created from a digital photograph (3).

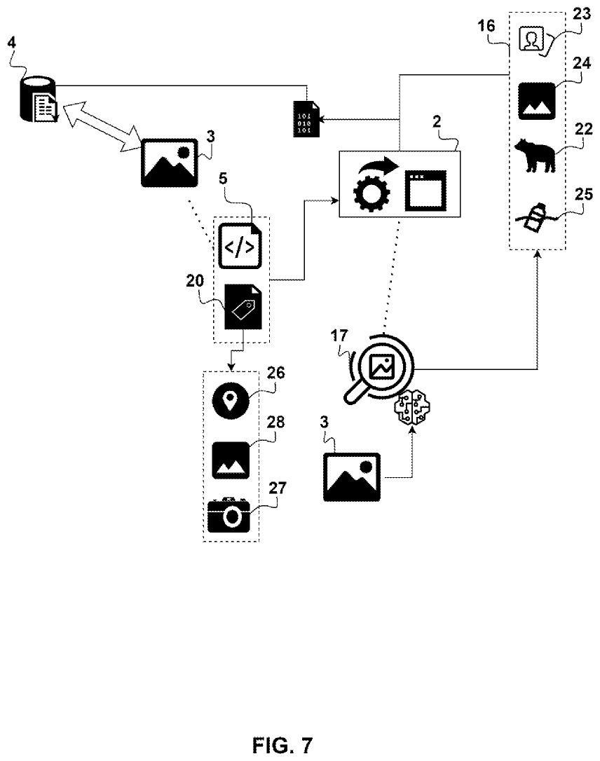

Referring to FIG. 7, in some embodiments of the present methods (1), step (100) of providing the association (2) may further comprise a sub-step (120) of extracting information (20) from the metadata of the digital photograph (3), the extracted information (20) including one or more of location information (26) indicating where the digital photograph (3) was taken; photographer information (27) indicating who has taken the digital photograph (3); and/or landscape information (28) indicating at least part of a landscape shown in the digital photograph (3).

The photographer information (27) may be a data, string, or any information configured to be read by a computer system and associate the digital photograph (3) with a photographer, editor, or legally entitled owner of the digital photograph (3) copyrights. For example, the photographer information (27) may be a digital signature, which may be verified by an ID external verification system, or distributed ledger technology (DLT) system, like a blockchain network.

The location information (26) may be a GPS tag or any other kind of data that may represent the geolocalization, address, or approximated location of the place where the digital photograph (3) was obtained.

Similarly, the landscape information (28) may be a data element or structure, or metadata element configured to be read by a computing system and associate the digital photograph (3) with a topic (25). The landscape information (28) may be the same landscape information (16) that can be automatically extracted in step (100) of assigning (2) a digital photograph (3) to one or more predefined classes (4). The landscape information (28) may also represent a simplified version of the landscape information (16) that can be automatically extracted in step (100) of assigning (2) a digital photograph (3) to one or more predefined classes (4). This allows reducing the size of the data structures (e.g., matrices, tensors, datasets) that are processed by the machine learning processes or algorithms that may take the landscape information (28) as input.

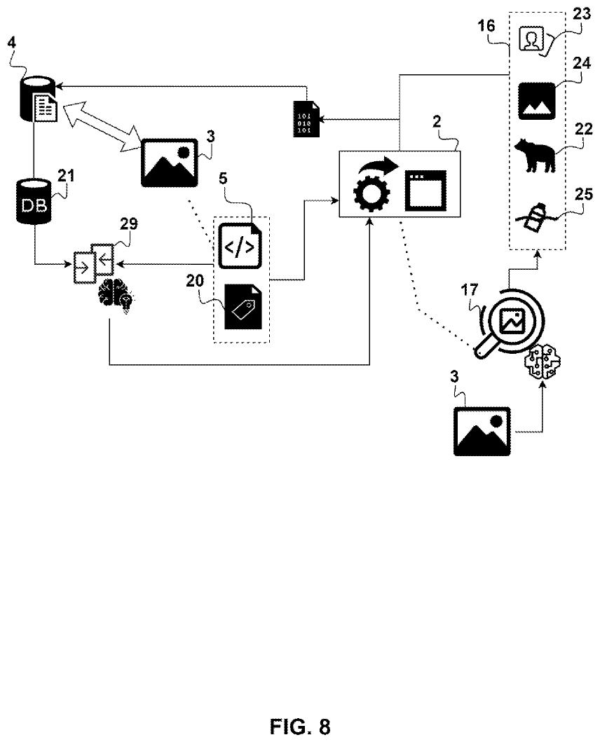

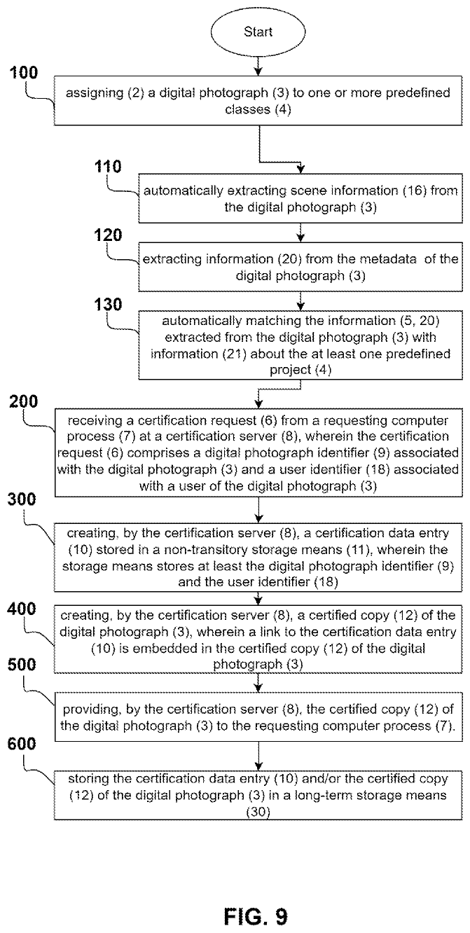

Referring to FIG. 8 and FIG. 9, in some embodiments of the instant invention, step (100) of providing the association (2) may further comprise a sub-step (130) of automatically matching (29) the characteristics (5, 20) extracted from the digital photograph (3) with information (21) about the at least one predefined project (4). This automatic matching (29) may be generated by a database management process configured to assign tags or relations to the digital photograph (3). If the digital photograph (3) is associated to a block of a blockchain system, the automatic matching (29) may include generating a hash identifier that is saved in the blockchain system. On the other hand, the automatic matching (29) may comprise using a machine-learning algorithm. The machine-learning algorithm may be a part, method, process or subprocess of the image classification machine-learning process (17). The machine-learning algorithm used in the automatic matching (29) may also be independent from the image classification machine-learning process (17).

These embodiments also allow having supplemental information associated with the digital photograph (3) that can be used in the processing steps (400, 500). Furthermore, this information may be used by a web scraping system/method or a search engine to classify and/or group the digital photograph (3) with other similar digital photographs (3).

In some embodiments of method (1), the image classification machine-learning process (17), and the machine-learning algorithm of the automatic matching (29) step, may be based on using a machine-learning model or machine-learning algorithm.

Machine learning may refer to algorithms and statistical models that computer systems can use to perform a specific task without using explicit instructions, instead of relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm.

In order for the machine-learning model to analyze the content of an image, the machine-learning model may be trained using training images as input and training content information as output. By training the machine-learning model with a large number of training images and/or training sequences (e.g., words or sentences) and associated training content information (e.g., labels or annotations), the machine-learning model “learns” to recognize the content of the images, so the content of images that are not included in the training data can be recognized using the machine-learning model.

The same principle may be used for other kinds of sensor data as well. By training a machine-learning model using training sensor data and a desired output, the machine-learning model “learns” a transformation between the sensor data and the output, which can be used to provide an output based on non-training sensor data provided to the machine-learning model. The provided data (e.g., sensor data, metadata and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training.

Apart from supervised learning, semi-supervised learning may be used. In semi-supervised learning, some of the training samples lack a corresponding desired output value. Supervised learning may be based on a supervised learning algorithm (e.g., a classification algorithm, a regression algorithm or a similarity learning algorithm. Classification algorithms may be used when the outputs are restricted to a limited set of values (categorical variables), i.e., the input is classified to one of the limited set of values. Regression algorithms may be used when the outputs may have any numerical value (within a range). Similarity, learning algorithms may be similar to both classification and regression algorithms, but are based on learning from examples using a similarity function that measures how similar or related two objects are.

Apart from supervised or semi-supervised learning, unsupervised learning may be used to train the machine-learning model. In unsupervised learning, (only) input data might be supplied, and an unsupervised learning algorithm may be used to find structure in the input data (e.g., by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, an anomaly detection (i.e., outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g., a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules represent a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may e.g., be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g., based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g., of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e., to achieve a desired output for a given input.

Alternatively, the machine-learning model may be a support vector machine, a random forest model or a gradient boosting model. Support vector machines (i.e., support vector networks) are supervised learning models with associated learning algorithms that may be used to analyze data (e.g., in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

In some embodiments of the presently disclosed methods (1) (not illustrated), the step (100) of assigning (2) a digital photograph (3) to one or more predefined classes (4) may comprise a substep of receiving the digital photograph (3) from a computer system (13, 14, 15, 16), preferably a computer system (14) on which a stock photo collection is stored; and storing the digital photograph (3) in a non-transitory storage means (11) of a computer system (13, 15) on which the certification server (8) operates.

An advantage provided by the aforementioned embodiments is that once the digital photograph (3) is stored in the non-transitory storage means (11), when a different user or terminal requests certifying the same digital photograph (3), it is not necessary to retransmit the digital photograph (3), and process same anew using method (1). Accordingly, this arrangement beneficially allows for reducing the payload of digital photograph (3) files being sent during the continuous operation of the method (1), thereby enabling a faster and more stable communication protocol, and further contributing to lower page loading times in the respective terminals and/or computer systems participating in method (1).

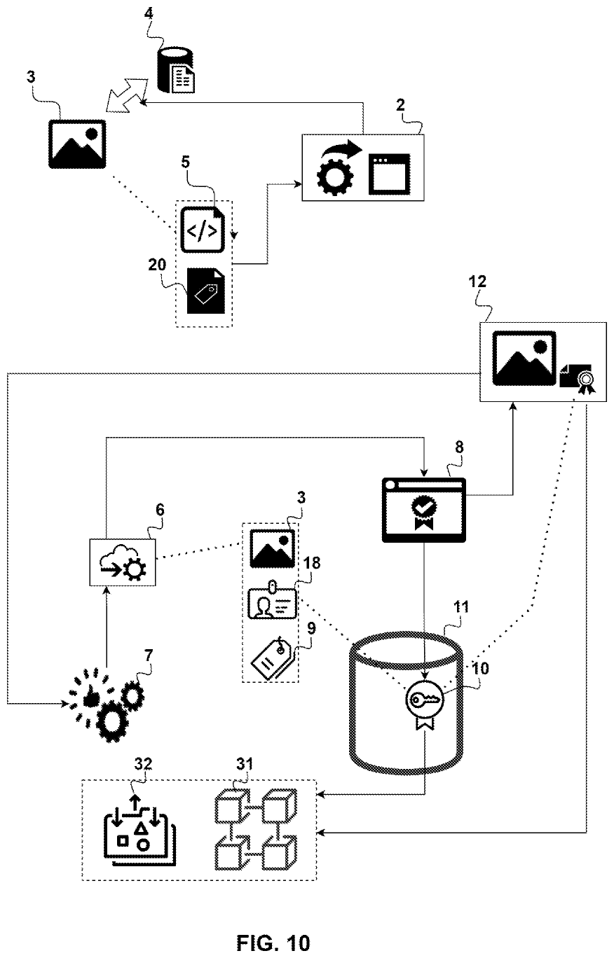

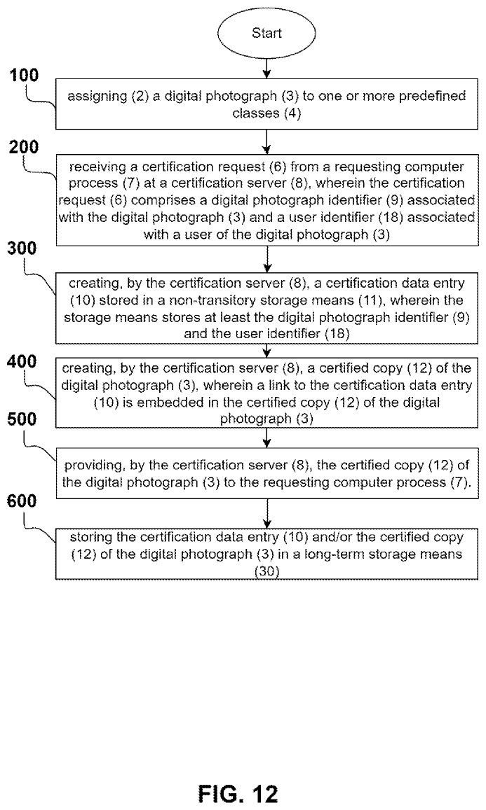

Referring to FIG. 10 and FIG. 12, any of the embodiments of the instant methods (1) may further comprise an additional step (600) of storing the certification data entry (10) and/or the certified copy (12) of the digital photograph (3) in a long-term storage means (30), the long-term storage means (30) comprising, e.g., one or more of a distributed ledger technology (DLT) system (31), in particular a blockchain network; and an InterPlanetary File System (IPFS) system (32). One of the advantages of these embodiments is improving the security of the system and preventing cyberattacks directed to alter the certificates or obtain unauthorized certified copies (12) of the digital photograph (3).

In any of the embodiments of the method (1) as described herein, the certification data entry (10) may comprise an indication of the user of the digital photograph (3), such as a name and/or an identifier of the user (e.g., the user identifier (18)); an indication of the digital photograph (3), such as a digital photograph identifier (9) of the digital photograph (3); and an indication of the at least one predefined class (4) assigned to the digital photograph (3), such as an identifier of the class (4). Optionally, the certification data entry (10) may further include one or more of a time of purchase; an expiry time of the usage of the digital photograph (3) by the user; and one or more license terms, such as “print only”. These embodiments beneficially allow having different classes of certification data entries (10) according to certain authorizations recorded for the user, e.g., the type of license or rule purchased and/or assigned to the user, wherein said user preferably is associated to a user identifier (18).

In any of the embodiments according to the disclosed methods (1), the link to the certification data entry (10) is established through linking information embedded in the certified copy (12) of the digital photograph (3) which enables locating the certification data entry (10), preferably via a uniform resource identifier (URI).

For example, the linking information may be embedded in a visible element of the certified copy (12) of the digital photograph (3), such as a watermark or a machine-readable code. This allows a user to visually identify the type of license that is associated to the certified copy (12). For example, the linking information may be a watermark like “for educational use only” that warns the user about using the certified copy (12) in unlicensed applications (e.g., for an advertisement of a commercial product).

Alternatively, the linking information is embedded in an invisible element of the certified copy (12) of the digital photograph (3), such as a metadata entry or steganographic information. It should be understood in the context of the present disclosure that the invisible element is invisible to the typical human perception, although there might be differences on pixel level. Furthermore, the linking information may be a blockchain hash associated to the digital photograph (3) and/or the certified copy (12).

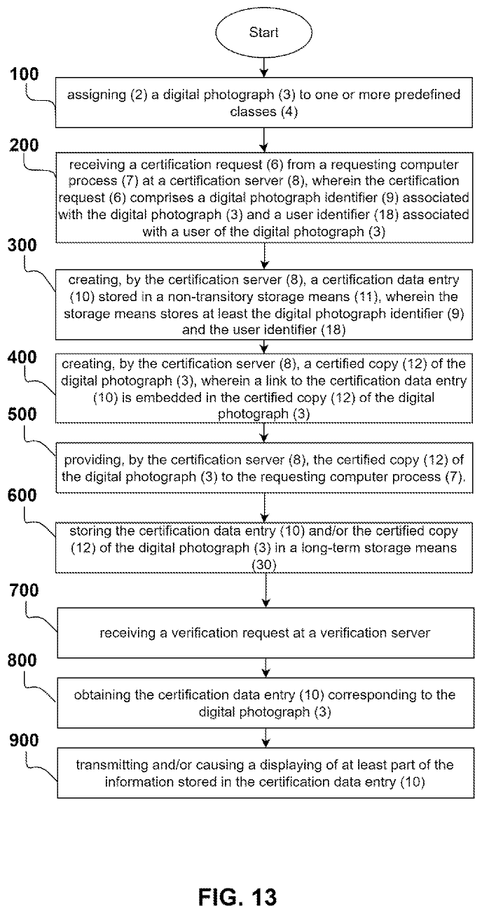

Referring to FIG. 13, any of the embodiments according to the disclosed methods (1) may further comprise a step (700) of receiving a verification request at a verification server. The verification request may comprise the certified copy (12) of the digital photograph (3), an indication of the certified copy (12) of the digital photograph (3) (e.g., a copy identifier, data file, or tag assigned to each certified copy (12)), the digital photograph (3), or an indication of the digital photograph (3) (e.g., the digital photograph identifier (9)). These embodiments may also include a step (800) of obtaining the certification data entry (10) corresponding to the digital photograph (3), and a step (900) of transmitting and/or causing a displaying of at least part of the information stored in the certification data entry (10). These embodiments allow validating automatically a previously generated certified copy (12) of the digital photograph (3). Furthermore, these embodiments of the method (1) allow detecting false, or counterfeit copies of the digital photograph (3) which are supposed to be certified copies (12) of the digital photograph (3). The verification server may be a machine learning process or may include a database management system configured to compare said indications with values associated with the certification data entry (10) and/or certified copy (12) saved in a validation database. Similarly, the verification server may execute the validation using a blockchain system, for example, by comparing a hash code associated with the certified copy (12) of the verification request with a hash code of a certified copy (12) stored in a validation database.

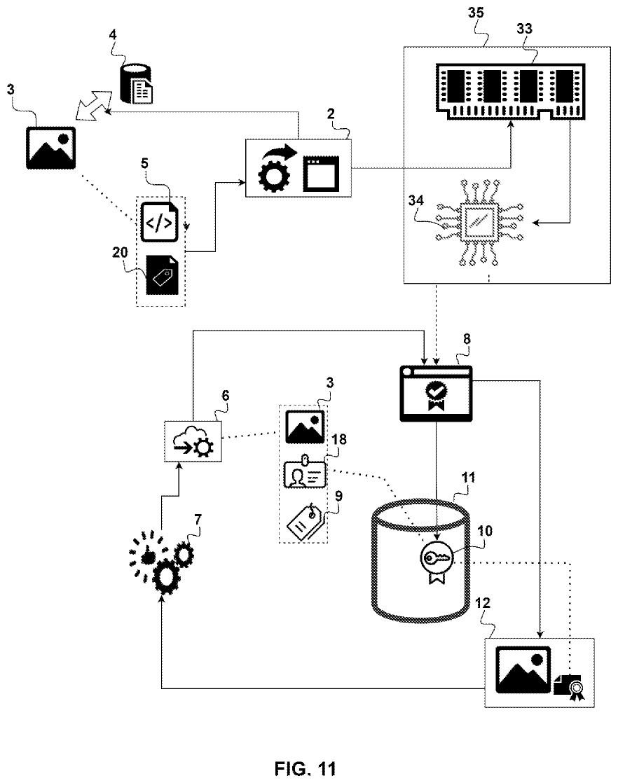

Referring to FIG. 11, the present disclosure also relates to a photograph certification apparatus (35) (in the following paragraphs, apparatus (35)) comprising a memory (33) and a processor (34).

The memory (33) may be configured for storing an assignment of a digital photograph (3) with one or more predefined classes (4), the assignment being based at least in part on one or more of a first characteristic (5) extracted from the digital photograph (3) and a second characteristic (20) based on metadata associated with the digital photograph (3).

The processor (34) may be configured for executing a certification server (8) configured for receiving a certification request (6) from a requesting computer process (7), wherein the certification request (6) comprises a digital photograph identifier (9) associated with the digital photograph (3) and a user identifier (18) associated with a user of the digital photograph (3). The processor (34) may be configured for creating a certification data entry (10) stored in a non-transitory storage means (11), wherein the storage means stores at least the digital photograph identifier (9) and the user identifier (18); and creating a certified copy (12) of the digital photograph (3), wherein a link to the certification data entry (10) is embedded in the certified copy (12) of the digital photograph (3). The processor (34) may also be configured for providing the certified copy (12) of the digital photograph (3) to the requesting computer process (7).

The memory (33) may include one or more memory elements suitable to the particular application, such as a main memory in the form of random access memory (RAM), one or more hard drives, and/or one or more drives that handle removable media such as compact disks (CD), flash memory cards, digital video disk (DVD), and the like.

The memory (33) may also be a memory module that can be selected from the group that includes RAM (cache memory, SRAM, DRAM, DDR), ROM memory (Flash, Cache, hard disks, SSD, EPROM, EEPROM, removable ROM memories (e.g., SD (miniSD, microSD, etc.), MMC (MultiMedia Card), Compact Flash, SMC (Smart Media Card), SDC (Secure Digital Card), MS (Memory Stick), etc.), etc.), etc.). SD (miniSD, microSD, etc.), MMC (MultiMedia Card), Compact Flash, SMC (Smart Media Card), SDC (Secure Digital Card), MS (Memory Stick), etc.), CD-ROM, Digital Versatile Disc (DVD) or other optical storage, magnetic cassettes, magnetic tapes, storage or any other means that can be used to store information that can be accessed by a computing unit, device, server or equivalent computing system that is known to a person skilled in the art.

The processor (34) may be any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), or any other type of processor or processing circuit.

Furthermore, the present disclosure relates to a system comprising the apparatus (35) and at least one computer system configured for hosting a stock photo collection.

The computer system may be a local computer device (e.g., personal computer, laptop, tablet computer or mobile phone) with one or more processors and one or more storage devices or may be a distributed computer system (e.g., a cloud computing system with one or more processors and one or more storage devices distributed at various locations, for example, at a local client and/or one or more remote server farms and/or data centers). The computer system may comprise any circuit or combination of circuits. In one embodiment, the computer system may include one or more processors which can be of any type.

Other types of circuits that may be included in the computer system may be a custom circuit, an application-specific integrated circuit (ASIC), or the like, such as, for example, one or more circuits (such as a communication circuit) for use in wireless devices including mobile telephones, tablet computers, laptop computers, two-way radios, and similar electronic systems. The computer system may also include a display device, one or more speakers, and a keyboard and/or controller, which can include a mouse, trackball, touch screen, voice-recognition device, or any other device that permits a system user to input information into and receive information from the computer system.

Furthermore, the present disclosure relates to a data processing apparatus or system comprising means for carrying out any of the embodiments of the method (1) herein-described. The data processing apparatus or system may include any of the embodiments of the apparatus (35).

The data processing apparatus or system, or the apparatus (35), may further include a communications module that may be selected from the group comprising wired communications modules, wireless communications modules and wired and wireless communications modules.

Examples of wireless communications modules are modules using a wireless communications technology that is selected from the group comprising Bluetooth, WiFi, RF ID (Radio Frequency Identification), UWB (Ultra Wide B-and), GPRS, Konnex or KNX, DMX (Digital MultipleX), WiMax and equivalent wireless communications technologies that are known to a person skilled in the art, and combinations thereof.

Similarly, a wired communications module can have a wired connection port that allows communication with external devices via a communications bus, which is selected among others from the group consisting of I2C (IIC Inter-Integrated Circuit), CAN (Controller Area Network), Ethernet, SPI (Serial Peripheral Interface), SCI (Serial Communication Interface), QSPI (Quad Serial Peripheral Interface), SCI (Serial Communication Interface), QSPI (Quad Serial Peripheral Interface) and QSPI (Quad Serial Peripheral Interface), Ethernet, SPI (Serial Peripheral Interface), SCI (Serial Communication Interface), QSPI (Quad Serial Peripheral Interface), 1-Wire, DDB (Domestic Digital Bus), Profibus and others known to a person skilled in the art.

The present disclosure further relates to embodiments relating to a computer program or a computer-readable means having stored thereon a computer program, the computer program comprising instructions which, when the program is executed by a computer, cause the computer to carry out any of the embodiments of the herein-described method (1). The program code may, for example, be stored on a machine-readable carrier.

The computer program can be written in any programming language or framework known to a person skilled in the art. For example, the computer program may be written in Java, JavaScript, Perl, PHP and C++, #C, Python, R-studio SQL, Swift, Ruby, Delphi, Visual Basic, D, HTML, HTML5, CSS, NodeJs, Angular, React, Go, RPA, .NET, Scala, Drupal, Ember, Labview and other programming languages and/or frameworks known to a person skilled in the art.

On the other hand, the computer-readable means can be selected from executable files, installable files, compact disks, RAM (cache memory, SRAM, DRAM, DDR), ROM memory (Flash, Cache, hard disks, SSD, EPROM, EEPROM, removable ROM memories (e.g., SD (miniSD, microSD, etc.), MMC (MultiMedia Card), Compact Flash, SMC (Smart Media Card), SDC (Secure Digital Card, MS (Memory Stick), etc.), MS (Memory Stick), among others. SD (miniSD, microSD, etc.), MMC (MultiMedia Card), Compact Flash, SMC (Smart Media Card), SDC (Secure Digital Card), MS (Memory Stick), among others), CD-ROM, Digital Versatile Disc (DVD) or other optical storage, magnetic cassettes, magnetic tapes, storage or any other media that can be used to store information and can be accessed by a processing unit.

The computer-readable storage medium may comprise instructions which, when executed by a computer, cause the computer to carry out a step of assigning (2) a digital photograph (3) to one or more predefined classes (4), the assigning (2) being based at least in part on one or more of a first characteristic (5) extracted from the digital photograph (3) and a second characteristic (20) based on metadata associated with the digital photograph (3). The computer-readable storage medium may further comprise instructions which, when executed by a computer, cause the computer to carry out a step of receiving a certification request (6) from a requesting computer process (7), wherein the certification request (6) comprises a digital photograph identifier (9) associated with the digital photograph (3) and a user identifier (18) associated with a user of the digital photograph (3).

Furthermore, the computer-readable storage medium may comprise instructions which, when executed by a computer, cause the computer to carry out a step of creating a certification data entry (10) stored in a non-transitory storage means (11), wherein the storage means (11) stores at least the digital photograph identifier (9) and the user identifier (18); a step of creating a certified copy (12) of the digital photograph (3), wherein a link to the certification data entry (10) is embedded in the certified copy (12) of the digital photograph (3); and a step of providing the certified copy (12) of the digital photograph (3) to the requesting computer process (7).

Additional examples of alternative aspects of the present disclosure relate to the following embodiments:
Embodiment 1. A photograph certification method, comprising:
   assigning a digital photograph to one or more predefined classes, the assigning being based at least in part on one or more of a first characteristic extracted from the digital photograph and a second characteristic based on metadata associated with the digital photograph;
   receiving a certification request from a requesting computer process at a certification server, wherein the certification request comprises a digital photograph identifier associated with the digital photograph and a user identifier associated with a user of the digital photograph;
   creating, by the certification server, a certification data entry stored in a non-transitory storage means, wherein the storage means stores at least the digital photograph identifier and the user identifier;
   creating, by the certification server, a certified copy of the digital photograph, wherein a link to the certification data entry is embedded in the certified copy of the digital photograph; and providing, by the certification server, the certified copy of the digital photograph to the requesting computer process.
Embodiment 2. The method of Embodiment 1, wherein the certification server operates on a computer system separate from a computer system of the requesting computer process.
Embodiment 3. The method of Embodiment 2, wherein the computer system of the requesting computer process is a stock photo platform configured for storing the digital photograph.
Embodiment 4. The method of any one of the preceding Embodiments, wherein the certification server is accessible via an application programming interface or a web service.
Embodiment 5. The method of Embodiment 1, wherein the certification server and the requesting computer process operate on a same computer system, wherein the computer system is configured for storing the digital photograph.
Embodiment 6. The method of any one of the preceding Embodiments, wherein the step of assigning the digital photograph to one or more predefined classes comprises automatically extracting landscape information as the first characteristic from the digital photograph, the landscape information indicating at least part of a landscape shown in the digital photograph.
Embodiment 7. The method of Embodiment 6, wherein the automatic extracting of the landscape information comprises processing the digital photograph using an image classification machine-learning algorithm.
Embodiment 8. The method of Embodiment 7, wherein the machine-learning algorithm has been trained to classify one or more of:
   an animal shown in the digital photograph;
   a person shown in the digital photograph, preferably including an ethnicity and/or social affiliation of the person;
   a natural environment shown in the digital photograph;
   a topic such as pollution, hunger, climate change and/or war.
Embodiment 9. The method of any one of the preceding Embodiments, wherein the step of assigning the digital photograph to one or more predefined classes comprises extracting the second characteristic from the metadata associated with the digital photograph, the second characteristic including one or more of:
   location information indicating where the digital photograph was taken;
   photographer information indicating who has taken the digital photograph;
   landscape information indicating at least part of a landscape shown in the digital photograph.
Embodiment 10. The method of any one of the preceding Embodiments, wherein the step of assigning the digital photograph to one or more predefined classes comprises automatically matching the first characteristic and/or the second characteristic extracted from the digital photograph with information about the one or more predefined classes.
Embodiment 11. The method of Embodiment 10, wherein the automatic matching comprises using a machine-learning algorithm.
Embodiment 12. The method of any one of the preceding Embodiments, wherein the step of assigning the digital photograph to one or more predefined classes comprises:
   receiving the digital photograph from a computer system, preferably a computer system on which a stock photo collection is stored;
   storing the digital photograph in a non-transitory storage means of a computer system on which the certification server operates.
Embodiment 13. The method of any one of the preceding Embodiments, further comprising storing the certification data entry and/or the certified copy of the digital photograph in long-term storage means, the long-term storage means comprising one or more of:
   a distributed ledger technology (DLT) system, in particular a blockchain network;
   an InterPlanetary File System (IPFS) system.
Embodiment 14. The method of any one of the preceding Embodiments, wherein the certification data entry comprises:
   an indication of the user of the digital photograph, such as a name and/or an identifier of the user;
   an indication of the digital photograph, such as an identifier of the photograph; and
   an indication of the one or more predefined classes assigned to the digital photograph, such as an identifier of the class;
   and, optionally, one or more of:
      a time of purchase;
      an expiry time of the usage of the digital photograph by the user;
      one or more usage terms, such as “print only”.
Embodiment 15. The method of any one of the preceding Embodiments, wherein the link to the certification data entry is established through linking information embedded in the certified copy of the digital photograph which enables locating the certification data entry, preferably via a uniform resource identifier (URI).
Embodiment 16. The method of Embodiment 15, wherein the linking information is embedded in a visible element of the certified copy of the digital photograph, such as a watermark or a machine-readable code.
Embodiment 17. The method of Embodiment 15, wherein the linking information is embedded in an invisible element of the certified copy of the digital photograph, such as a metadata entry or steganographic information.
Embodiment 18. The method of any one of the preceding Embodiments, further comprising:
   receiving a verification request at a verification server, the verification request comprising the certified copy of the digital photograph, an indication of the certified copy of the digital photograph, the digital photograph, or an indication of the digital photograph;
   obtaining the certification data entry corresponding to the digital photograph; transmitting and/or causing a displaying of at least part of the information stored in the certification data entry.
Embodiment 19. A data processing apparatus or system comprising means for carrying out the method of any one of the preceding Embodiments.
Embodiment 20. A system comprising the apparatus of the previous Embodiment and at least one computer system configured for hosting a stock photo collection.
Embodiment 21. A computer program or a computer-readable medium having stored thereon a computer program, the computer program comprising instructions which, when the program is executed by a computer, cause the computer to carry out the method of any one of the preceding Embodiments.

1. A photograph certification method, comprising:
assigning a digital photograph to one or more predefined classes, the assigning being based at least in part on one or more of a first characteristic extracted from the digital photograph and a second characteristic based on metadata associated with the digital photograph;
receiving a certification request from a requesting computer process at a certification server, wherein the certification request comprises a digital photograph identifier associated with the digital photograph and a user identifier associated with a user of the digital photograph;
creating, by the certification server, a certification data entry stored in a non-transitory storage means, wherein the storage means stores at least the digital photograph identifier and the user identifier;
creating, by the certification server, a certified copy of the digital photograph, wherein a link to the certification data entry is embedded in the certified copy of the digital photograph; and
providing, by the certification server, the certified copy of the digital photograph to the requesting computer process.

2. The method of claim 1, wherein the certification server operates on a computer system separate from a computer system of the requesting computer process.

3. The method of claim 2, wherein the computer system of the requesting computer process is a stock photo platform configured for storing the digital photograph.

4. The method of claim 2, wherein the certification server is accessible via an application programming interface or a web service.

5. The method of claim 1, wherein the certification server and the requesting computer process operate on a same computer system, wherein the computer system is configured for storing the digital photograph.

6. The method of claim 1, wherein the step of assigning the digital photograph to one or more predefined classes comprises automatically extracting landscape information as the first characteristic from the digital photograph, the landscape information indicating at least part of a landscape shown in the digital photograph.

7. The method of claim 6, wherein the automatic extracting of the landscape information comprises processing the digital photograph using an image classification machine-learning algorithm.

8. The method of claim 7, wherein the machine-learning algorithm has been trained to classify one or more of:
an animal shown in the digital photograph;
a person shown in the digital photograph, preferably including an ethnicity and/or social affiliation of the person;
a natural environment shown in the digital photograph; and
a topic such as pollution, hunger, climate change and/or war.

9. The method of claim 1, wherein the step of assigning the digital photograph to one or more predefined classes comprises extracting the second characteristic from the metadata associated with the digital photograph, the second characteristic including one or more of:
location information indicating where the digital photograph was taken;
photographer information indicating who has taken the digital photograph; and
landscape information indicating at least part of a landscape shown in the digital photograph.

10. The method of claim 1, wherein the step of assigning the digital photograph to one or more predefined classes comprises automatically matching the first characteristic and/or the second characteristic extracted from the digital photograph with information about the one or more predefined classes.

11. The method of claim 10, wherein the automatic matching comprises using a machine-learning algorithm.

12. The method of claim 1, wherein the step of assigning the digital photograph to one or more predefined classes comprises:
receiving the digital photograph from a computer system, preferably a computer system on which a stock photo collection is stored; and
storing the digital photograph in a non-transitory storage means of a computer system on which the certification server operates.

13. The method of claim 1, further comprising storing the certification data entry and/or the certified copy of the digital photograph in long-term storage means, the long-term storage means comprising one or more of:
a distributed ledger technology (DLT) system, in particular a blockchain network; and
an InterPlanetary File System (IPFS) system.

14. The method of claim 1, wherein the certification data entry comprises:
an indication of the user of the digital photograph, such as a name and/or an identifier of the user;
an indication of the digital photograph, such as an identifier of the photograph; and
an indication of the one or more predefined classes assigned to the digital photograph, such as an identifier of the class;
and, optionally, one or more of:
a time of purchase;
an expiry time of the usage of the digital photograph by the user;
one or more usage terms, such as “print only”.

15. The method of claim 1, wherein the link to the certification data entry is established through linking information embedded in the certified copy of the digital photograph which enables locating the certification data entry, preferably via a uniform resource identifier (URI).

16. The method of claim 15, wherein the linking information is embedded in a visible element of the certified copy of the digital photograph, such as a watermark or a machine-readable code.

17. The method of claim 15, wherein the linking information is embedded in an invisible element of the certified copy of the digital photograph, such as a metadata entry or steganographic information.

18. The method of claim 1, further comprising:
receiving a verification request at a verification server, the verification request comprising the certified copy of the digital photograph, an indication of the certified copy of the digital photograph, the digital photograph, or an indication of the digital photograph;
obtaining the certification data entry corresponding to the digital photograph; and
transmitting and/or causing a displaying of at least part of the information stored in the certification data entry.

19. A photograph certification apparatus, comprising:
a memory configured for storing an assignment of a digital photograph with one or more predefined classes, the assignment being based at least in part on one or more of a first characteristic extracted from the digital photograph and a second characteristic based on metadata associated with the digital photograph; and
a processor configured for executing a certification server configured for:
receiving a certification request from a requesting computer process, wherein the certification request comprises a digital photograph identifier associated with the digital photograph and a user identifier associated with a user of the digital photograph;
creating a certification data entry stored in a non-transitory storage means, wherein the storage means stores at least the digital photograph identifier and the user identifier;
creating a certified copy of the digital photograph, wherein a link to the certification data entry is embedded in the certified copy of the digital photograph; and
providing the certified copy of the digital photograph to the requesting computer process.

20. A computer-readable storage medium comprising instructions which, when executed by a computer, cause the computer to carry out:
assigning a digital photograph to one or more predefined classes, the assigning being based at least in part on one or more of a first characteristic extracted from the digital photograph and a second characteristic based on metadata associated with the digital photograph;
receiving a certification request from a requesting computer process, wherein the certification request comprises a digital photograph identifier associated with the digital photograph and a user identifier associated with a user of the digital photograph;
creating a certification data entry stored in a non-transitory storage means, wherein the storage means stores at least the digital photograph identifier and the user identifier;
creating a certified copy of the digital photograph, wherein a link to the certification data entry is embedded in the certified copy of the digital photograph; and
providing the certified copy of the digital photograph to the requesting computer process.
